(19) United States
(12) Patent Application Publication
(10) Pub. No.: US 2012/0052275 A1
(43) Pub. Date: Mar. 1, 2012

(54) GLASS SUBSTRATE, CHEMICALLY STRENGTHENED GLASS SUBSTRATE AND COVER GLASS, AND METHOD FOR MANUFACTRUING THE SAME

(75) Inventors: Kazuaki HASHIMOTO, Tokyo (JP); Tetsuo TAKANO, Tokyo (JP); Akihiro KOYAMA, Takarazuka-shi (JP); Mikiko MORISHITA, Pyeongtaek-si (KR)

(73) Assignees: AVANSTRATE INC., Yokkaichi-shi (JP); HOYA CORPORATION, Tokyo (JP)

(21) Appl. No.: 13/219,255

(22) Filed: Aug. 26, 2011

(30) Foreign Application Priority Data
Aug. 30, 2010 (JP) 2010-192114

(51) Int. Cl. C03C 3/093; C03C 3/091; C03B 17/06; B32B 17/00; C03C 21/00; C03C 15/00; C03C 3/087; B32B 7/02

(52) U.S. Cl. 428/215; 501/70; 501/66; 501/67; 65/90; 65/30.14; 65/31

(57) ABSTRACT

Provided is a cover glass having a down-drawable composition including, in mass percent: 50%-70% SiO₂, 5%-20% Al₂O₃, 6%-20% Na₂O, 0%-10% K₂O, 0%-10% MgO, above 2%-20% CaO, and 0%-4.8% ZrO₂ wherein, (i) 46.5%≦(SiO₂−½Al₂O₃)≦59%, (ii) 0.3<CaO/RO, where RO represents a total mass percent of one or more compounds selected from the group consisting of MgO, CaO, SrO and BaO included in the glass substrate, (iii) SrO+BaO<10%, (iv) 0≦(ZrO₂+TiO₂)/SiO₂)<0.07, and (v) 0≦B₂O₃/R¹₂O<0.1, where R¹₂O represents a total mass percent of one or more compounds selected from the group consisting of Li₂O, Na₂O and K₂O included in the glass substrate.

### CROSS-REFERENCE TO RELATED APPLICATIONS

This application claims priority to Japanese Patent Application No. 2010-192114, filed on Aug. 30, 2010. The entire disclosure of Japanese Patent Application No. 2010-192114 is hereby incorporated herein by reference.

### TECHNICAL FIELD

The present invention relates to a cover glass employing strengthened glass and method of manufacturing the same, and in particular relates to a cover glass applicable to the protection of the display of a mobile phone, a digital camera, a PDA, a flat panel display, or the like.

### BACKGROUND ART

Strengthened glass is obtained by chemically reinforcing the strength of a glass substrate by applying an ion-exchange treatment, and such strengthened glass has been applied as a cover glass for protecting, for example, the display of mobile terminals such as mobile phones and digital cameras (e.g., see JP 2009-57271A).

In recent years, mobile terminals have tended to become thinner, include more functions, and have more complex shapes. For this reason, there has been demand for the ability to form recessions, holes, and the like that include a negative curvature portion in strengthened glass used as a cover glass for mobile terminals and the like.

However, since strengthened glass has a high mechanical strength, there is the problem of difficulty in external shape modification, such as forming recessions, holes, and the like that include a negative curvature portion.

In order to address this problem, a technique has been proposed in which a cover glass having a desired shape is obtained by forming a recession or hole in a glass substrate through etching in a step performed before ion-exchange treatment, and thereafter applying the ion-exchange treatment (e.g., see JP 2009-167086A).

### SUMMARY OF INVENTION

Although there is demand for the ability to inexpensively mass-produce cover glass, the etching processing time for shape modification cannot be shortened in JP 2009-167086A, causing the problem that yield cannot be sufficiently improved.

In order to address this problem, it is conceivable to improve the etching speed of the glass substrate itself, which is to be used as the strengthened glass. However, improving the etching speed of the glass substrate leads to the issue of poor anti-devitrification characteristics of the glass.

In other words, since it is difficult to obtain both a favorable glass etching speed and favorable anti-devitrification characteristics, it has not been possible to sufficiently improve the yield of cover glass.

There is demand for the use of down-drawing in the glass formation method. This is because unlike a glass substrate formed using another method, a glass substrate formed using down-drawing has an improved etching speed and does not need a polishing step to be performed after formation since the surface of the glass substrate has very high smoothness, thus enabling realizing a reduction in cost and an improvement in yield.

However, if the anti-devitrification characteristics of the glass become poor as described above, down-drawing cannot be used in the formation method, and the cover glass cannot be inexpensively mass-produced.

The present invention has been achieved in view of such circumstances, and an object thereof is to provide a cover glass that solves the above-described issues, can obtain both a favorable glass etching speed and favorable anti-devitrification characteristics, and can improve yield, and a method of manufacturing the same.

The inventors of the present invention made the following findings as a result of extensive research for achieving the aforementioned object.

It was found that glass obtained by melting a frit material so as to have a specific glass composition has good anti-devitrification characteristics, and a glass substrate for chemical strengthening obtained by forming the melt glass into a plate shape through down-drawing enables sufficiently improving the etching speed as well, thus making it possible to obtain both favorable anti-devitrification characteristics and an improved etching speed.

It was also found that a cover glass made up of a chemically strengthened glass substrate having superior quality can be obtained with high yield by, preferably, carrying out etching processing on a glass substrate for chemical strengthening obtained by down-drawing in this way, and thereafter applying an ion-exchange treatment.

The present invention has been achieved based on such findings.

Specifically, the following are aspects of the present invention.

A glass substrate having a down-drawable composition including, in mass percent:

| | |
|---|---|
| SiO₂ | 50%-70% |
| Al₂O₃ | 5%-20% |
| Na₂O | 6%-20% |
| K₂O | 0%-10% |
| MgO | 0%-10% |
| CaO | above 2%-20% |
| ZrO₂ | 0%-4.8% |

Wherein, (i) 46.5%≦(SiO₂-½Al₂O₃)≦59%, where SiO₂ and Al₂O₃ represent the mass percents of SiO₂ and Al₂O₃, respectively, in the glass substrate; (ii) 0.3<CaO/RO, where CaO represents the mass percent of CaO in the glass substrate and RO represents a total mass percent of one or more compounds selected from the group consisting of MgO, CaO, SrO and BaO included in the glass substrate; (iii) SrO+BaO<10%, where SrO and BaO represent mass percents of SrO and BaO, respectively, in the glass substrate; (iv) 0≦(ZrO₂+TiO₂)/SiO₂)<0.07, where ZrO₂ and TiO₂ represent the mass percents of ZrO₂ and TiO₂, respectively, in the glass substrate; and (v) 0≦B₂O₃/R¹₂O<0.1, where B₂O₃ represents a mass percent of B₂O₃ in the glass substrate and R¹₂O represents a total mass percent of one or more compounds selected from the group consisting of Li₂O, Na₂O and K₂O included in the glass substrate.

In the glass substrate as recited above, preferably, Li₂O/(RO+Li₂O)<0.3, where Li₂O represents the mass percent of Li₂O in the glass substrate.

In the glass substrate as recited above, preferably, 4%<RO.

In the glass substrate as recited above, preferably, (ZrO₂+TiO₂+½B₂O₃+½Na₂O)/SiO₂<0.3, where Na₂O represent the mass percent of Na₂O in the glass substrate.

In the glass substrate as recited above, preferably, TiO₂<3%.

In the glass substrate as recited above, preferably, a liquidus temperature of the glass substrate is less than 1090° C.

A chemically strengthened glass substrate includes the glass substrate as recited above including a compressive stress layer at a surface of thereof, which is formed by a chemically strengthening treatment applied to the glass substrate.

In the chemically strengthened glass substrate as recited above, a plate thickness of the glass substrate is preferably 0.3 mm to 1.5 mm, a compressive layer depth is preferably 25 μm to 70 μm, and a compressive stress value is preferably 400 MPa to 900 MPa.

A cover glass includes the chemically strengthened glass substrate as recited above.

In the cover glass as recited above, a plate thickness of the glass substrate is preferably 0.3 mm to 1.5 mm, a compressive layer depth is preferably 25 μm to 70 μm, and a compressive stress value is preferably 400 MPa to 900 MPa.

A method for manufacturing a glass substrate including melting a glass raw material and forming the glass substrate having a plate-shape by a down-draw glass forming method using the melted frit material.

The glass raw material is blended so as to have a glass composition including, in mass percent,

| | |
|---|---|
| SiO₂ | 50%-70% |
| Al₂O₃ | 5%-20% |
| Na₂O | 6%-20% |
| K₂O | 0%-10% |
| MgO | 0%-10% |
| CaO | above 2%-20% |
| ZrO₂ | 0%-4.8% |

Wherein, (i) 46.5%≦(SiO₂−½Al₂O₃)≦59%, where SiO₂ and Al₂O₃ represent the mass percents of SiO₂ and Al₂O₃, respectively, in the frit material, (ii) 0.3<CaO/RO, where CaO represents the mass percent of CaO in the frit material and RO represents a total mass percent of one or more compounds selected from the group consisting of MgO, CaO, SrO and BaO included in the frit material, (iii) SrO+BaO<10%, where SrO and BaO represent mass percents of SrO and BaO, respectively, in the frit material, (iv) 0≦(ZrO₂+TiO₂)/SiO₂)<0.07, where ZrO₂ and TiO₂ represent the mass percents of ZrO₂ and TiO₂, respectively, in the frit material, and (v) 0≦B₂O₃/R¹₂O<0.1, where B₂O₃ represents a mass percent of B₂O₃ in the frit material and R¹₂O represents a total mass percent of one or more compounds selected from the group consisting of Li₂O, Na₂O and K₂O included in the frit material.

In the method as recited above, in the frit material, preferably, Li₂O/(RO+Li₂O)<0.3, where Li₂O represents the mass percent of Li₂O in the frit material.

In the method as recited above, preferably, in the frit material, 4%<RO.

In the method as recited above, preferably, in the frit material, (ZrO₂+TiO₂+½B₂O₃+½Na₂O)/SiO₂<0.3, where Na₂O represent the mass percent of Na₂O in the frit material.

In the method as recited above, preferably, in the frit material, TiO₂<3%.

A method for manufacturing a chemically strengthened glass substrate includes: preparing the glass substrate by using the method as recited above; and applying an ion-exchange treatment to the glass substrate.

A method for manufacturing a cover glass including: preparing the glass substrate by using the method as recited above; and performing etching on the glass substrate.

The method as described above, preferably further includes applying an ion-exchange treatment to the glass substrate after the performing of the etching.

A glass substrate manufactured by the method as described above.

A chemically strengthened glass substrate manufactured by the method as described above.

A cover glass manufactured by the method as described above.

The present invention enables providing a cover glass that can obtain both a favorable glass etching speed and favorable anti-devitrification characteristics, and can improve yield, and a method of manufacturing the same.

### BRIEF DESCRIPTION OF DRAWINGS

FIG. 1 is a graph showing the relationship between [SiO₂ content percent−½ Al₂O₃ content percent] and etching speed.

FIG. 2 is a graph showing the relationship between [SiO₂ content percent−½ Al₂O₃ content percent] and liquidus temperature (Tl).

FIG. 3 is a graph showing the relationship between [SiO₂ content percent−½ Al₂O₃ content percent] and glass transition temperature (Tg).

FIG. 4 is a graph showing the relationship between CaO/RO content ratio and liquidus temperature (Tl).

### DESCRIPTION OF EMBODIMENTS

The following describes the present invention. In the present description, the percentages indicating the content percents of components constituting glass represent mass percents unless otherwise particularly stated.

First, a description of a cover glass of the present embodiment will be given.

### Cover Glass

The cover glass of the present embodiment is made up of a chemically strengthened glass substrate that includes a compressive stress layer at a surface of thereof, which is formed by a chemically strengthening treatment applied to a glass substrate having a down-drawable composition including, in mass percent:

| | |
|---|---|
| SiO₂ | 50%-70% |
| Al₂O₃ | 5%-20% |
| Na₂O | 6%-20% |
| K₂O | 0%-10% |
| MgO | 0%-10% |
| CaO | above 2%-20% |
| ZrO₂ | 0%-4.8% |

Wherein, (i) 46.5%≦(SiO₂−½Al₂O₃)≦59%, where SiO₂ and Al₂O₃ represent the mass percents of SiO₂ and Al₂O₃, respectively, in the glass substrate, (ii) 0.3<CaO/RO, where CaO represents the mass percent of CaO in the glass substrate and RO represents a total mass percent of one or more compounds selected from the group consisting of MgO, CaO, SrO and BaO included in the glass substrate, (iii) SrO+BaO<10%, where SrO and BaO represent mass percents of SrO and BaO, respectively, in the glass substrate, (iv) 0≦(ZrO₂+TiO₂)/SiO₂)<0.07, where ZrO₂ and TiO₂ represent the mass percents of ZrO₂ and TiO₂, respectively, in the glass substrate, and (v) 0≦B₂O₃/R¹₂O<0.1, where B₂O₃ represents a mass percent of B₂O₃ in the glass substrate and R¹₂O represents a total mass percent of one or more compounds selected from the group consisting of Li₂O, Na₂O and K₂O included in the glass substrate.

In the present embodiment, the cover glass is a cover used for protecting the display screen of, for example, a flat panel display or a mobile terminal such as a mobile phone, a digital camera, or a PDA. However, the cover glass of the present embodiment is not limited to these applications, and can also be applied to, for example, the substrate of a touch panel display.

First, a description of the composition of the glass constituting a chemically strengthened glass substrate will be given.

### SiO₂

SiO₂ is a component that forms the framework of glass and has the effect of raising the chemical durability and heat resistance of glass. If the content percent of SiO₂ is less than 50%, the etching speed tends to improve, but vitrification is difficult, and the above-described effect cannot be sufficiently obtained. On the other hand, if this content percent exceeds 70%, the glass readily devitrifies, it is difficult to melt and mold the frit material, and it is difficult to homogenize the glass due to a rise in viscosity, thus making it difficult to mass-produce inexpensive glass using down-drawing. Also, the rate of thermal expansion decreases excessively, and it becomes difficult to match the coefficient of thermal expansion with that of peripheral materials such as metals and organic adhesives. Furthermore, the ion exchange rate decreases due to an excessive rise in low-temperature viscosity, thus making it impossible to obtain sufficient strength in the case of performing chemical strengthening as well. Accordingly, the content percent of SiO₂ is 50% to 70%, preferably 53% to 67%, more preferably 53% to 65%, even more preferably 55% to 65%, and particularly preferably 58% to 62%.

### Al₂O₃

Al₂O₃ is a component that forms the framework of glass and has the effect of raising the chemical durability and heat resistance of glass, as well as ion exchange performance and etching speed. If the content percent of Al₂O₃ is less than 5%, the above-described effect cannot be sufficiently obtained. On the other hand, if this content percent exceeds 20%, it is difficult to melt the glass, and it is difficult to mold the glass due to a rise in its viscosity, thus making it difficult to mass-produce inexpensive glass using down-drawing. Also, acid resistance decreases excessively, making the glass not preferable for use in a cover glass. Furthermore, the glass readily devitrifies, and the anti-devitrification characteristics also degrade, thus making it impossible to be applied to overflow down-drawing as well. Accordingly, the content percent of Al₂O₃ is 5% to 20%, preferably 8% to 17%, more preferably 10% to 16%, and particularly preferably 11% to 15%.

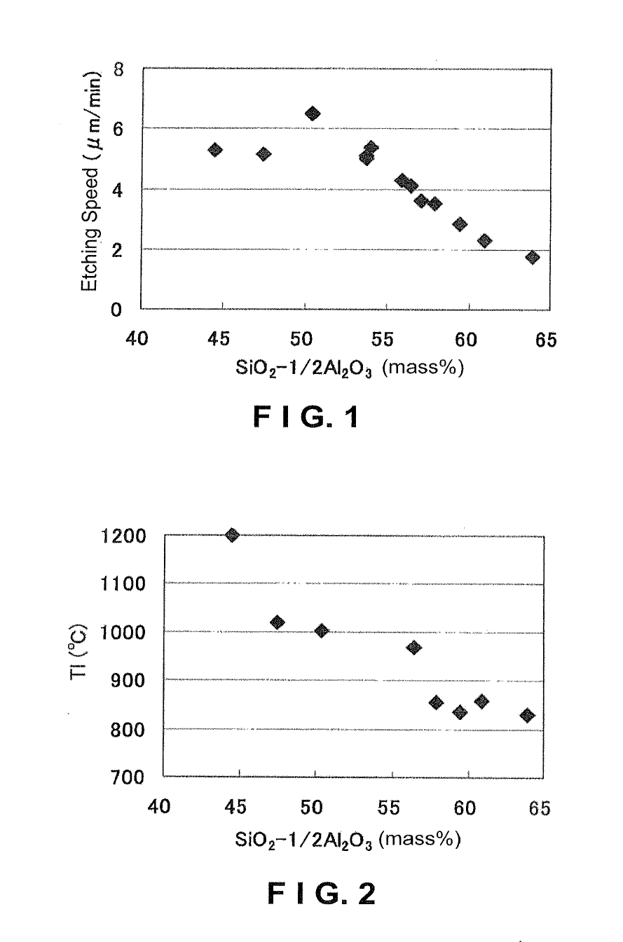

In the present embodiment, it is necessary that [SiO₂ content percent−½ Al₂O₃ content percent] is 46.5% to 59%. As shown in FIG. 1, if [SiO₂ content percent−½ Al₂O₃ content percent] is less than or equal to 59%, the etching speed can be effectively improved. In consideration of yield, it is preferable that the etching speed is greater than or equal to 2.4 μm/min. On the other hand, as shown in FIG. 2, if [SiO₂ content percent−½ Al₂O₃ content percent] is less than 46.5%, the etching speed is greater than or equal to 5 μm/min, but the anti-devitrification characteristics are poor since the liquidus temperature (devitrification temperature) rises as shown in FIG. 2. Accordingly, in order to realize both favorable anti-devitrification characteristics and an improvement in etching speed, which is the issue described above, it is necessary that [SiO₂ content percent−½ Al₂O₃ content percent] is 46.5% to 59%. Note that the range of [SiO₂ content percent−½ Al₂O₃ content percent] is preferably 50% to 58%, more preferably 50% to 56%, even more preferably 50% to 55%, and particularly preferably 50% to 54%.

### B₂O₃

B₂O₃ is a component that lowers the viscosity of glass and promotes the dissolution and clarification of glass. If the content percent of B₂O₃ exceeds 5%, the acid resistance of the glass decreases, and volatilization increases, thus making homogenization of the glass difficult. Also, an increase is volatilization causes nonuniformity in the glass, and nonuniformity in the etching speed of the glass substrate as well. Specifically, the etching precision decreases, and therefore a glass substrate containing an excessive amount of B₂O₃ is not suited for, for example, etching for shape modification for which high precision is required. Furthermore, the strain point also decreases, thus leading to the disadvantage that the glass undergoes deformation when carrying out heat treatment on the glass substrate. Accordingly, the content percent of B₂O₃ is preferably 0% to 5%, more preferably 0% to 3%, even more preferably 0% to less than 2%, and particularly preferably less than 0.01% (i.e., it is intentionally not allowed to be contained, except as an impurity).

### Li₂O

Li₂O is one ion exchange component, and is a component that reduces the viscosity of glass and improves the meltability and moldability of glass. Li₂O is also a component that improves the Young's modulus of glass. Furthermore, Li₂O has an excellent effect of raising the compressive stress value in an alkali metal oxide. However, if the content percent of Li₂O is too high, the liquid-phase viscosity decreases, and the glass readily devitrifies, thus making it difficult to mass-produce inexpensive glass using down-drawing. Also, the coefficient of thermal expansion of the glass rises excessively, and the thermal shock resistance of the glass decreases, and thus it becomes difficult to match the coefficient of thermal expansion with that of peripheral materials such as metals and organic adhesives. Furthermore, there is the disadvantage that the degradation of ion exchange salts speeds up in the ion-exchange treatment applied in the step for strengthening the glass substrate. Also, an excessive reduction in the low-temperature viscosity causes stress relaxation in the heating step performed after chemical strengthening, and causes a decrease in the compressive stress value, thus making it impossible to obtain sufficient strength. Accordingly, the content percent of Li₂O is preferably 0% to 10%, more preferably 0% to 5%, even more preferably 0% to 2%, still more preferably 0% to 1%, even further preferably 0% to 0.02%, and it is particularly preferable that Li₂O is intentionally not allowed to be contained, except as an impurity.

### Na₂O

Na₂O is an ion exchange component, and is a component that reduces the high-temperature viscosity of glass and improves the meltability and moldability of glass. Na₂O is also a component that improves the anti-devitrification characteristics of glass. If the content percent of Na₂O is less than 6%, the meltability of the glass decreases, and the cost required for melting increases. Ion exchange performance also decreases, and therefore sufficient strength cannot be obtained. Also, the coefficient of thermal expansion decreases excessively, and thus it becomes difficult to match the coefficient of thermal expansion with that of peripheral materials such as metals and organic adhesives. Furthermore, the glass readily devitrifies, and the anti-devitrification characteristics also decrease, thus making it impossible to be applied to overflow down-drawing, which makes it difficult to mass-produce inexpensive glass. On the other hand, if this content percent exceeds 20%, the low-temperature viscosity decreases, the rate of thermal expansion rises excessively, and shock resistance decreases, thus making it difficult to match the coefficient of thermal expansion with that of peripheral materials such as metals and organic adhesives. A decrease in anti-devitrification characteristics also occurs due to poor glass balance, thus making it difficult to mass-produce inexpensive glass using down-drawing. Accordingly, the content percent of Na₂O is 6% to 20%, preferably 9% to 17%, more preferably 11% to 17%, even more preferably 13% to 17%, and particularly preferably 13% to 16%.

Also, in the present embodiment, it is preferable that [Na₂O content percent−Al₂O₃ content percent] is −10% to 10%. If [Na₂O content percent−Al₂O₃ content percent] is −10% to 10%, it is possible to not only solve the issues of the present invention described above, but also improve the meltability of the glass while maintaining a suitable rate of thermal expansion and favorable heat resistance. This enables melting the glass at a lower temperature, thus enabling further reducing cost in cover glass manufacturing. Note that the range of [Na₂O content percent−Al₂O₃ content percent] is more preferably −5% to 10%, even more preferably −5% to 5%, even further preferably −3% to 5%, and particularly preferably 0% to 3%.

### K₂O

K₂O is an ion exchange component, and its inclusion enables improving the ion exchange performance of glass. K₂O is also a component that reduces the high-temperature viscosity of glass, improves the meltability and moldability of glass, and improves anti-devitrification characteristics at the same time. However, if the content percent of K₂O is too high, the low-temperature viscosity decreases, the rate of thermal expansion rises excessively, and shock resistance decreases, thus making the glass not preferable for use in a cover glass. Also, it becomes difficult to match the coefficient of thermal expansion with that of peripheral materials such as metals and organic adhesives. A decrease in anti-devitrification characteristics also occurs due to poor glass balance, thus making it difficult to mass-produce inexpensive glass using down-drawing. Accordingly, the content percent of K₂O is 0% to 10%, preferably 0% to less than 5.6%, more preferably greater than 0% to less than 5.6%, even more preferably greater than 0% to 4%, and particularly preferably 0.5% to 4%.

In the present embodiment, it is preferable that the content percent of R¹₂O (R¹ being one or more selected from among Li, Na, and K) is 6% to 25%. If the content percent of R¹₂O is less than 6%, ion exchange is not performed to a sufficient extent, thus making it impossible to obtain sufficient strength, and making application in a cover glass difficult. On the other hand, if the content percent of R¹₂O exceeds 25%, the liquidus temperature rises due to poor glass balance, making application in down-drawing difficult, thus making it difficult to mass-produce inexpensive glass. In order to obtain both a favorable mechanical strength and favorable anti-devitrification characteristics, and improve yield, the content percent of R¹₂O is preferably 10% to 25%, more preferably 13% to 20%, and particularly preferably 15% to 19%.

In the present embodiment, it is necessary that the content ratio B₂O₃/R¹₂O (R¹ being one or more selected from among Li, Na, and K) is 0 to less than 0.1. B₂O₃ readily combines with an alkali metal oxide and volatilizes as an alkaline borate, and in particular, Li⁺ having a small ion radius has a high degree of mobility in glass melt and readily volatilizes from the melt surface, and therefore a concentration gradient is formed even down into the glass interior, and striae readily appear on the glass surface. In other words, if the amount of volatilized B₂O₃ increases, inhomogeneity occurs in the glass substrate that is manufactured, and if etching processing is carried out on such a glass substrate, etching unevenness will appear due to the inhomogeneity of the glass substrate. However, alkali metal oxides are an essential component of glass that is chemically strengthened through an ion-exchange treatment. In view of this, if the content ratio B₂O₃/R¹₂O is in the range of 0 to less than 0.1, it is possible to effectively suppress inhomogeneity of the glass and etching unevenness. This enables not only solving the issues of the present invention described above, but also preventing unevenness in the etching speed, thus making it possible to obtain strengthened glass having a desired shape with favorable yield. Note that the content ratio B₂O₃/R¹₂O is preferably 0 to 0.07, more preferably 0 to 0.03, even more preferably 0 to 0.005, and particularly preferably 0. In view of etching unevenness as well, it is most preferable that the content percent of Li₂O is less than 0.01% (i.e., it is intentionally not allowed to be contained, except as an impurity), as described above.

### MgO

MgO is a component that lowers the viscosity of glass and promotes the dissolution and clarification of glass. Also, since the rate at which MgO raises the density of glass is low among alkaline earth metals, MgO is a component that is advantageous for improving meltability while reducing the weight of the glass that is obtained. MgO is also a component that improves moldability and raises the strain point and Young's modulus of glass. However, if the content percent of MgO is too high, a decrease in anti-devitrification characteristics occurs, thus making it difficult to mass-produce inexpensive glass using down-drawing. Accordingly, the content percent of MgO is 0% to 10%, preferably 0% to 6%, more preferably 0% to less than 3%, and particularly preferably 1% to 3%.

### CaO

CaO is a component that lowers the viscosity of glass and promotes the dissolution and clarification of glass. Also, since the proportion required to raise the density of glass is small among alkaline earth metals, CaO is a component that is advantageous for improving meltability while reducing the weight of the glass that is obtained. CaO is also a component that improves moldability and raises the strain point and Young's modulus of glass. However, if the content percent of CaO is too high, a decrease in anti-devitrification characteristics occurs, thus making it difficult to mass-produce inexpensive glass using down-drawing. Ion exchange performance also becomes poor, thus making it impossible to obtain sufficient strength and causing a decrease in yield. On the other hand, the inclusion of CaO enables reducing the liquidus temperature and improving anti-devitrification characteristics and meltability, and therefore the content percent of CaO is greater than 2% to 20%, preferably greater than 2% to 15%, more preferably greater than 2% to 10%, and particularly preferably greater than 2% to 6%. The inclusion of CaO in these ranges enables not only solving the issues described above, but also melting the glass at a lower temperature, thus enabling further reducing cost in cover glass manufacturing. Also, the inclusion of CaO also enables improving both ion exchange performance and the strain point, and thus is suitable for use in a cover glass for which a high mechanical strength is required. This is because a sufficient compressive stress layer can be formed at the surface of the glass substrate, and it is possible to prevent the loss of the compressive stress layer formed at the surface when performing heat treatment.

### SrO

SrO is a component that lowers the viscosity of glass and promotes the melting and clarification of glass. SrO is also a component that improves moldability and raises the strain point and Young's modulus of glass. However, if the content percent of SrO is too high, the density of the glass rises, thus making the glass unsuitable in, for example, a cover glass for which a small size and light weight are required. Also, the rate of thermal expansion rises excessively, and it becomes difficult to match the coefficient of thermal expansion with that of peripheral materials such as metals and organic adhesives. Furthermore, ion exchange performance decreases, thus making it difficult to obtain a sufficient mechanical strength. Accordingly, the content percent of SrO is preferably 0% to 10%, more preferably 0% to 5%, even more preferably 0% to 2%, even further preferably 0% to 0.5%, and it is particularly preferable that SrO is substantially not included.

### BaO

BaO is a component that lowers the viscosity of glass and promotes the melting and clarification of glass. BaO is also a component that improves moldability and raises the strain point and Young's modulus of glass. However, if the content percent of BaO is too high, the density of the glass rises, thus making the glass unsuitable for use in, for example, a cover glass for which a small size and light weight are required. Also, the rate of thermal expansion rises excessively, and it becomes difficult to match the coefficient of thermal expansion with that of peripheral materials such as metals and organic adhesives. Furthermore, ion exchange performance decreases, thus making it difficult to obtain a sufficient mechanical strength. Accordingly, the content percent of BaO is preferably 0% to 10%, more preferably 0% to 5%, even more preferably 0% to 2%, and even further preferably 0% to 0.5%. Note that due to having a large impact on the environment, it is particularly preferable that the content percent of BaO is less than 0.01%, that is to say, BaO is intentionally not allowed to be contained, except as an impurity.

In the present embodiment, [SrO content percent+BaO content percent] is less than 10%. If [SrO content percent+BaO content percent] is less than 10%, it is possible to effectively prevent a rise in the density of the glass. In other words, setting [SrO content percent+BaO content percent] so as to be less than 10% not only solves the issues described above, but also enables obtaining the effect of enabling a reduction in the weight of a cover glass or the like. Note that [SrO content percent+BaO content percent] is preferably 0% to 8%, more preferably 0 to 5%, even more preferably 0% to 2%, even further preferably 0% to 1%, and it is particularly preferable that SrO and BaO are substantially not included.

Here, it is preferable that the content percent of RO (R being at least any one selected from among Mg, Ca, Sr, and Ba) is 2% to 20%. If this content percent is less than 2%, it becomes difficult to melt the glass due to a rise in its viscosity, and the cost required for melting increases. Heat resistance also decreases due to a decrease in the strain point, and there are cases where the glass undergoes deformation during chemical strengthening processing, and thus the glass is not suitable for a cover glass. On the other hand, if the content percent of RO exceeds 20%, chemical durability decreases. Accordingly, if the content percent of RO is in the range of 2% to 20%, it is possible to improve the meltability and heat resistance of the glass while maintaining chemical durability. Note that since it is preferable to reduce the viscosity of the glass in order to apply an overflow down-draw technique, it is preferable that the content percent of RO is greater than 4%, more preferably greater than 4% to 16%, even more preferably 5% to 13%, and even further preferably 5% to 8%.

Also, in the present embodiment, it is necessary that the content ratio CaO/RO (R being at least any one selected from among Mg, Ca, Sr, and Ba) is greater than 0.3. As shown in FIG. 4, if the content ratio CaO/RO is greater than 0.3, it is possible to effectively reduce the liquidus temperature, thus enabling effectively improving the anti-devitrification characteristics. It is also possible to effectively improve the strain point and improve heat resistance as well. In other words, it is possible to improve the anti-devitrification characteristics, which is one of the issues described above, while furthermore improving heat resistance, thus making it possible to also prevent the problem of the glass undergoing deformation during chemical strengthening processing and other types of heat treatment. Note that the content ratio CaO/RO is preferably greater than or equal to 0.35, and particularly preferably greater than or equal to 0.4. Also, the upper limit of the content ratio CaO/RO is preferably less than or equal to 0.95, more preferably less than or equal to 0.85, and particularly preferably less than or equal to 0.75. Specifically, the content ratio CaO/RO is preferably 0.35 to 0.95, more preferably 0.35 to 0.85, and particularly preferably 0.4 to 0.75.

Note that it can be said that it is more preferable that CaO is included in view of the above as well.

Also, in the present embodiment, it is preferable that the content ratio Li₂O/(RO+Li₂O) (R being at least any one selected from among Mg, Ca, Sr, and Ba) is less than 0.3. If the content ratio Li₂O/(RO+Li₂O) is less than 0.3, it is possible to effectively reduce the liquidus temperature, thus enabling effectively improving the anti-devitrification characteristics. It is also possible to effectively improve the strain point and improve heat resistance as well. In other words, it is possible to improve the anti-devitrification characteristics, which is one of the issues described above, while furthermore improving heat resistance, thus making it possible to prevent the problem of the glass undergoing deformation during chemical strengthening processing and other types of heat treatment. Furthermore, it is possible to suppress the degradation of ion exchange salts in the ion-exchange treatment applied in the step for strengthening the glass substrate, and reduce the cost of manufacturing strengthened glass. Note that the content ratio Li₂O/(RO+Li₂O) is more preferably less than or equal to 0.08, even more preferably less than or equal to 0.05, even furthermore preferably less than or equal to 0.01, and particularly preferably 0.

### ZnO

ZnO is a component that raises ion exchange performance, and in particular is a component that highly effectively raises the compressive stress value as well as reduces the high-temperature viscosity of glass without reducing its low-temperature viscosity. However, if the content percent of ZnO is too high, the glass undergoes phase separation, and the anti-devitrification characteristics degrade. Also, the density of the glass rises, and therefore the glass is not suitable for use in, for example, a cover glass for which a small size and light weight are required. Accordingly, the content percent of ZnO is preferably 0% to 6%, more preferably 0% to 4%, even more preferably 0% to 1%, even further preferably 0% to 0.1%, and particularly preferably less than 0.01% (i.e., it is intentionally not allowed to be contained, except as an impurity).

### ZrO₂

ZrO₂ is a component that significantly improves ion exchange performance as well as raises the strain point of glass and the viscosity in the vicinity of the glass liquidus temperature. ZrO₂ is also a component that improves the heat resistance of glass. However, if the content percent of ZrO₂ is too high, the liquidus temperature rises, and the anti-devitrification characteristics degrade. Accordingly, in order to prevent degradation in the anti-devitrification characteristics, the content percent of ZrO₂ is less than or equal to 4.8%, and preferably less than or equal to 4%. Also, including ZrO₂ enables effectively improving heat resistance, which is critical in a cover glass and a touch panel display substrate, and ion exchange performance, which is critical in the chemical strengthening of a glass substrate, and therefore the content percent of ZrO₂ is preferably greater than or equal to 0.1%, more preferably greater than or equal to 0.5%, even more preferably greater than or equal to 1%, and particularly preferably greater than or equal to 2%. Specifically, the content percent of ZrO₂ is preferably 0.1% to 4.8%, more preferably 0.5% to 4%, even more preferably 1% to 4%, and particularly preferably 2% to 4%. In other words, setting the content percent of ZrO₂ so as to be in these ranges enables improving the anti-devitrification characteristics while also improving heat resistance and ion exchange performance, which is one of the issues described above. This enables reducing the ion exchange time and improving yield. It is also possible to prevent the problem of the glass undergoing deformation during chemical strengthening processing and other types of heat treatment, and improve the cover glass yield.

### TiO₂

TiO₂ is a component that improves ion exchange performance, while also being a component that reduces the high-temperature viscosity of glass. However, if the content percent of TiO₂ is too high, the anti-devitrification characteristics degrade. Furthermore, the glass becomes stained, and thus is not preferable for use in a cover glass or the like. Also, staining of the glass causes a reduction in ultraviolet light transmittance, and therefore in the case of performing processing using ultraviolet curable resin, there is the disadvantage that the ultraviolet curable resin cannot be sufficiently cured. Accordingly, the content percent of TiO₂ is preferably 0% to 5%, more preferably 0% to less than 3%, even more preferably 0% to 1%, even further preferably 0% to 0.01%, and it is particularly preferable that TiO₂ is intentionally not allowed to be contained, except as an impurity.

In the present embodiment, the content ratio (ZrO₂+TiO₂)/SiO₂ is 0 to less than 0.07. In the case of modifying the shape of the glass substrate through etching, there are cases where an ion-exchange treatment is applied after etching processing. In such ion-exchange treatment, there are cases where a change in shape occurs due to internal stress in the glass substrate caused by excessive ion exchange. Specifically, excessive ion exchange causes deformation to occur in the glass substrate, and therefore even if the etching precision is high, the glass substrate is not preferable for use as a cover glass or touch panel display substrate. Furthermore, if excessive ion exchange occurs, impact also increases when the strengthened glass breaks, and therefore such glass is particularly not preferable for use as a cover glass for, for example, a mobile terminal used in proximity to the body. Here, if the content ratio (ZrO₂+TiO₂)/SiO₂ is 0 to 0.07, it is possible to effectively suppress excessive ion exchange. Note that the content ratio (ZrO₂+TiO₂)/SiO₂ is preferably 0.005 to 0.067, more preferably 0.01 to 0.063, even more preferably 0.02 to 0.060, and particularly preferably 0.03 to 0.058. If the content ratio (ZrO₂+TiO₂)/SiO₂ is in these ranges, it is possible to improve the anti-devitrification characteristics while preventing excessive ion exchange, and furthermore improve heat resistance as well.

Also, in the present embodiment, it is preferable that the content ratio (ZrO₂+TiO₂+½B₂O₃+½Na₂O)/SiO₂ is 0 to less than 0.3. In the case of modifying the shape of the glass substrate through etching, there are cases where an ion-exchange treatment is applied after etching processing. In such ion-exchange treatment, there are cases where a change in shape occurs due to internal stress in the glass substrate caused by excessive ion exchange. Specifically, excessive ion exchange causes deformation to occur in the glass substrate, and therefore even if the etching precision high, the glass substrate is not preferable for use as a cover glass or touch panel display substrate. Furthermore, if excessive ion exchange occurs, impact also increases when the strengthened glass breaks, and therefore such glass is particularly not preferable for use as a cover glass for, for example, a mobile terminal used in proximity to the body. Here, if the content ratio (ZrO₂+TiO₂+½B₂O₃+½Na₂O)/SiO₂ is 0 to less than 0.3, it is possible to effectively suppress excessive ion exchange. Note that the content ratio (ZrO₂+TiO₂+½B₂O₃+½Na₂O)/SiO₂ is preferably 0.05 to less than 0.3, more preferably 0.1 to less than 0.3, and particularly preferably 0.15 to less than 0.2. Also, if the content ratio (ZrO₂+TiO₂+½B₂O₃+½Na₂O)/SiO₂ is in these ranges, it is possible to improve the anti-devitrification characteristics while preventing excessive ion exchange, and furthermore improve heat resistance as well.

### P₂O₅

P₂O₅ is a component that raises ion exchange performance, and in particular is a component that highly effectively increases the thickness of the compressive stress layer. However, if the content percent of P₂O₅ is too high, the glass undergoes phase separation, and water resistance degrades. Accordingly, the content percent of P₂O₅ is preferably 0% to 10%, more preferably 0% to 4%, even more preferably 0% to 1%, even further preferably 0% to 0.1%, and particularly preferably less than 0.01% (i.e., it is intentionally not allowed to be contained, except as an impurity).

### Clarifying Agent

A clarifying agent is a component necessary for clarifying glass. If the content percent of the clarifying agent is less than 0.001%, its effect cannot be obtained, and if its content percent exceeds 5%, it becomes a cause of devitrification, staining, and the like. In view of this, the total content percent of the clarifying agent is preferably 0.001% to 5%, more preferably 0.01% to 3%, even more preferably 0.05% to 1%, and particularly preferably 0.05% to 0.5%.

There is no particular limitation on the clarifying agent, as long as it has a small environmental burden and has excellent glass clarification characteristics. Examples of the clarifying agent include at least any one selected from among metal oxides such as tin oxide, iron oxide, cerium oxide, terbium oxide, molybdenum oxide, and tungsten oxide.

However, since tin oxide is a component that readily causes glass to devitrify, in order prevent the tin oxide from causing devitrification while raising the clarification characteristics, the content percent of tin oxide is preferably 0.01% to 0.5%, more preferably 0.05% to 0.3%, and even more preferably 0.1% to 0.2%.

Also, since iron oxide is a component that readily causes glass to become stained, in order obtain a suitable transmittance while raising the clarification characteristics, the content percent of iron oxide is preferably 0.05% to 0.2%, more preferably 0.05% to 0.15%, and even more preferably 0.05% to 0.10%.

The content percent of cerium oxide is preferably 0% to 1.2%, more preferably 0.01% to 1.2%, even more preferably 0.05% to 1.0%, and particularly preferably 0.3% to 1.0%.

Also, particularly in the case where there is a desire for the glass to have a high transmittance, it is desirable to apply SO₃ as the clarifying agent. The content percent of SO₃ is preferably 0.001% to 5%, more preferably 0.01% to 3%, even more preferably 0.05% to 1%, even further preferably 0.05% to 0.5%, and particularly preferably 0.05% to 0.20%. Also, in the case of applying SO₃ as the clarifying agent, an even higher clarification effect can be obtained by causing carbon and the sulfate serving as the SO₃ source to coexist in the melting step. Note that as described above, it is also possible to cause SO₃ and the clarifying agent to coexist.

Also, As₂O₃, Sb₂O₃, and PbO are substances that undergo a reaction that is accompanied by valence fluctuation in melt glass and have the effect of clarifying the glass. However, since these substances have a large environmental burden, the glass substrate of the present embodiment is limited such that As₂O₃, Sb₂O₃, and PbO are substantially not contained in the glass. Note that in the present embodiment, “As₂O₃, Sb₂O₃, and PbO are substantially not contained” means that their content percent is less than 0.01%, that is to say, they are intentionally not allowed to be contained, except as an impurity.

A rare-earth oxide such as Nb₂O₅ or La₂O₃ is a component that raises the Young's modulus of glass. However, if the content percent of the rare-earth oxide is too high, the anti-devitrification characteristics degrade. Accordingly, the content percent of the rare-earth oxide such as Nb₂O₅ or La₂O₃ is preferably less than or equal to 3%, more preferably less than or equal to 1%, even more preferably less than or equal to 0.5%, and particularly preferably less than 0.1% (i.e., it is intentionally not allowed to be contained, except as an impurity).

Note that in the present embodiment, components that stain glass such as Co and Ni are not preferable due to reducing the transmittance of the glass substrate and the strengthened glass obtained after an ion-exchange treatment. For example, in the case of use in a touch panel display, such components are not preferable since the visibility of the touch panel display is impaired if the transmittance of the glass substrate or the strengthened glass decreases. Accordingly, the content percent of a transition metal element such as Co or Ni that stains glass is preferably less than or equal to 1%, more preferably less than or equal to 0.5%, even more preferably less than or equal to 0.05%, and particularly preferably less than 0.05% (i.e., it is intentionally not allowed to be contained, except as an impurity).

Next is a description of a cover glass manufacturing method of the present embodiment.

### Cover Glass Manufacturing Method

The cover glass manufacturing method of the present embodiment is a method for manufacturing a glass substrate including: (x) melting a frit material including, in mass percent,

| | |
|---|---|
| SiO₂ | 50%-70% |
| Al₂O₃ | 5%-20% |
| Na₂O | 6%-20% |
| K₂O | 0%-10% |
| MgO | 0%-10% |
| CaO | above 2%-20% |
| ZrO₂ | 0%-4.8% |

wherein, (i) 46.5%≦(SiO₂−½Al₂O₃)≦59%, where SiO₂ and Al₂O₃ represent the mass percents of SiO₂ and Al₂O₃, respectively, in the frit material, (ii) 0.3<CaO/RO, where CaO represents the mass percent of CaO in the frit material and RO represents a total mass percent of one or more compounds selected from the group consisting of MgO, CaO, SrO and BaO included in the frit material, (iii) SrO+BaO<10%, where SrO and BaO represent mass percents of SrO and BaO, respectively, in the frit material, (iv) 0≦(ZrO₂+TiO₂)/SiO₂)<0.07, where ZrO₂ and TiO₂ represent the mass percents of ZrO₂ and TiO₂, respectively, in the frit material, and (v) 0≦B₂O₃/R¹₂O<0.1, where B₂O₃ represents a mass percent of B₂O₃ in the frit material and R¹₂O represents a total mass percent of one or more compounds selected from the group consisting of Li₂O, Na₂O and K₂O included in the frit material.

The method further includes (y) forming the glass substrate having a plate-shape by a down-draw glass forming method using the melted fit material; and (z) applying an ion-exchange treatment to the glass substrate.

The glass composition is the same as that of the cover glass described above.

### (x) Step

The (x) step is a step of melting a frit material obtained by preparing various components so as to achieve the glass composition described above.

Specifically, frit materials corresponding to the various components are weighed and prepared, and then supplied to a melting container made of fireproof brick, platinum, a platinum alloy, or the like for heating and melting, and thereafter clarification and homogenization are performed so as to prepare melt glass having a desired composition.

### (y) Step

The (y) step is a molding step in which the melt glass that was prepared in the (x) step and has the desired composition is molded into a plate shape by down-drawing.

Examples of methods for molding into a plate shape include a down-draw method, a float method, a redraw method, and a roll out method. The down-draw method is employed in the present invention. This is because the main surface of a glass substrate molded using the down-draw method is a surface obtained by performing hot molding, and thus has very high smoothness. In other words, molding glass using the down-draw method eliminates the need for a polishing step after molding, thus enabling further improving yield. Furthermore, performing molding using the down-draw method enables obtaining a glass substrate whose surface is free of micro cracks. Also, in the case where the shape of the glass substrate is modified through an etching step, resist patterns formed on the two main surfaces of the glass substrate are used as masks, and when both main surfaces of the glass substrate are etched, etching can be performed uniformly on both main surfaces. In other words, due to having a uniform composition, there is an increase in the dimensional precision of etching, and a favorable cross-sectional shape is obtained for the end faces of the cover glass or touch panel display substrate.

Furthermore, both main surfaces of a glass substrate molded using the down-draw method have a uniform composition, and in the later-described ion exchange, there is no difference in the ion exchange rate between the main surfaces, thus making it possible to prevent warpage after ion exchange that occurs due to a difference in composition. In other words, it is possible to produce homogenous cover glass and touch panel display substrates, improve yield, and reduce cost. Also, a glass substrate molded using the down-draw method has a higher etching speed than the case of using another molding method such as the float method.

### (z) Step

The (z) step is a step of applying an ion-exchange treatment to the glass substrate molded into a plate shape.

The cover glass of the present embodiment is manufactured by applying an ion-exchange treatment to the plate-shaped glass substrate formed in the (y) step as described above. More specifically, it is possible to perform chemical strengthening by immersing the glass substrate, after it has been cleaned, into a treating bath, which is made up of 100% KNO₃ and is kept at approximately 500° C., for approximately five hours, and causing Na⁺ ions in the surface portion of the glass to be exchanged with K⁺ ions in the treating bath. Note that the temperature, time, ion exchange liquid, and the like used during ion-exchange treatment can be modified appropriately.

In this cover glass manufacturing method, an etching step serving as the (y′) step can be provided between the (y) step and the (z) step.

### (y′) Step

The (y′) step is an etching step provided if desired between the (y) step and the (z) step.

Although the case of performing etching processing for modifying the shape of the cover glass before the ion-exchange treatment step is described as an example in the present embodiment, there is no limitation to this.

First, both main surfaces of the plate-shaped glass substrate formed as described above are coated with a resist material. Next, the resist material is exposed via a photomask having a pattern with a desired external shape. There are no particular limitations on the external shape, and for example, the external shape may include a portion having a negative curvature.

Next, the exposed resist material is developed so as to form a resist pattern in the area other than the etching target area of the glass substrate, and etching is performed in the etching target area of the glass substrate. At this time, if a wet etchant is used as the etchant, the glass substrate is etched isotropically. Accordingly, the end faces of the glass substrate are formed into inclined faces that project outward the most in a central portion and curve gently from the central portion toward both main surface sides. Note that it is preferable that the border between an inclined face and a main surface and the border between inclined faces have a rounded shape.

There are no particular limitations on the resist material used in the etching step, and it is possible to apply a material having resistance to the etchant used when etching the glass using the resist pattern as a mask. For example, glass is generally eroded by wet etching with an aqueous solution containing hydrofluoric acid or by dry etching with a fluorine-based gas, and therefore a resist material having excellent hydrofluoric acid resistance, for example, is suitable. Also, it is possible to apply, as the etchant, a mixed acid containing at least one acid from among hydrofluoric acid, sulfuric acid, nitric acid, hydrochloric acid, and fluorosilicate. Using this mixed acid aqueous solution as the etchant enables obtaining a cover glass that has been given a desired shape.

Also, performing shape modification using etching enables easily realizing a complex external shape by merely adjusting the mask pattern. Furthermore, performing shape modification through etching enables further improving yield and reducing processing cost. Note that an alkaline solution containing KOH, NaOH, or the like can be used as a detachment fluid for detaching the resist material from the glass substrate. The type of resist material, etchant, and detachment fluid can be appropriately selected in accordance with the material of the glass substrate.

As described above, modifying the shape of the cover glass using etching enables obtaining a cover glass having end faces whose surface roughness is highly smooth. In other words, it is possible to prevent the appearance of micro cracks that always appear when performing shape modification by machining, and to further improve the mechanical strength of the cover glass.

Next is a description of a chemically strengthened glass substrate of the present embodiment.

### Chemically Strengthened Glass Substrate

This chemically strengthened glass substrate includes a compressive stress layer at a surface of thereof, which is formed by a chemically strengthening treatment applied to a glass substrate having a down-drawable composition including, in mass percent:

| | |
|---|---|
| SiO₂ | 50%-70% |
| Al₂O₃ | 5%-20% |
| Na₂O | 6%-20% |
| K₂O | 0%-10% |
| MgO | 0%-10% |
| CaO | above 2%-20% |
| ZrO₂ | 0%-4.8% |

Wherein, (i) 46.5%≦(SiO₂−½Al₂O₃)≦59%, where SiO₂ and Al₂O₃ represent the mass percents of SiO₂ and Al₂O₃, respectively, in the glass substrate, (ii) 0.3<CaO/RO, where CaO represents the mass percent of CaO in the glass substrate and RO represents a total mass percent of one or more compounds selected from the group consisting of MgO, CaO, SrO and BaO included in the glass substrate, (iii) SrO+BaO<10%, where SrO and BaO represent mass percents of SrO and BaO, respectively, in the glass substrate, (iv) 0≦(ZrO₂+TiO₂)/SiO₂)<0.07, where ZrO₂ and TiO₂ represent the mass percents of ZrO₂ and TiO₂, respectively, in the glass substrate, and (v) 0≦B₂O₃/R¹₂O<0.1, where B₂O₃ represents a mass percent of B₂O₃ in the glass substrate and R¹₂O represents a total mass percent of one or more compounds selected from the group consisting of Li₂O, Na₂O and K₂O included in the glass substrate.

The glass composition is the same as that of the cover glass described above.

Next is a description of a chemically strengthened glass substrate manufacturing method of the present embodiment.

### Chemically Strengthened Glass Substrate Manufacturing Method

This chemically strengthened glass substrate manufacturing method is a method for manufacturing a chemically strengthened glass substrate including: (x) melting a frit material including, in mass percent,

| | |
|---|---|
| SiO₂ | 50%-70% |
| Al₂O₃ | 5%-20% |
| Na₂O | 6%-20% |
| K₂O | 0%-10% |
| MgO | 0%-10% |
| CaO | above 2%-20% |
| ZrO₂ | 0%-4.8% |

Wherein, (i) 46.5%≦(SiO₂−½Al₂O₃)≦59%, where SiO₂ and Al₂O₃ represent the mass percents of SiO₂ and Al₂O₃, respectively, in the frit material, (ii) 0.3<CaO/RO, where CaO represents the mass percent of CaO in the frit material and RO represents a total mass percent of one or more compounds selected from the group consisting of MgO, CaO, SrO and BaO included in the frit material, (iii) SrO+BaO<10%, where SrO and BaO represent mass percents of SrO and BaO, respectively, in the frit material, (iv) 0≦(ZrO₂+TiO₂)/SiO₂)<0.07, where ZrO₂ and TiO₂ represent the mass percents of ZrO₂ and TiO₂, respectively, in the frit material, and (v) 0≦B₂O₃/R¹₂O<0.1, where B₂O₃ represents a mass percent of B₂O₃ in the frit material and R¹₂O represents a total mass percent of one or more compounds selected from the group consisting of Li₂O, Na₂O and K₂O included in the frit material.

The method further includes: (y) forming the glass substrate having a plate-shape by a down-draw glass forming method using the melted frit material; and

(z) applying an ion-exchange treatment to the glass substrate.

The (x) step, the (y) step, and the (z) step are the same as those of the cover glass manufacturing method described above.

Next is a description of a glass substrate for chemical strengthening of the present embodiment.

### Glass Substrate for Chemical Strengthening

This glass substrate for chemical strengthening has a down-drawable composition including, in mass percent:

| | |
|---|---|
| SiO₂ | 50%-70% |
| Al₂O₃ | 5%-20% |
| Na₂O | 6%-20% |
| K₂O | 0%-10% |
| MgO | 0%-10% |
| CaO | above 2%-20% |
| ZrO₂ | 0%-4.8% |

Wherein, (i) 46.5%≦(SiO₂−½Al₂O₃)≦59%, where SiO₂ and Al₂O₃ represent the mass percents of SiO₂ and Al₂O₃, respectively, in the glass substrate, (ii) 0.3<CaO/RO, where CaO represents the mass percent of CaO in the glass substrate and RO represents a total mass percent of one or more compounds selected from the group consisting of MgO, CaO, SrO and BaO included in the glass substrate, (iii) SrO+BaO<10%, where SrO and BaO represent mass percents of SrO and BaO, respectively, in the glass substrate, (iv) 0≦(ZrO₂+TiO₂)/SiO₂)<0.07, where ZrO₂ and TiO₂ represent the mass percents of ZrO₂ and TiO₂, respectively, in the glass substrate, and (v) 0≦B₂O₃/R¹₂O<0.1, where B₂O₃ represents a mass percent of B₂O₃ in the glass substrate and R¹₂O represents a total mass percent of one or more compounds selected from the group consisting of Li₂O, Na₂O and K₂O included in the glass substrate.

The glass composition is the same as that of the cover glass described above.

Next is a description of a glass substrate for chemical strengthening manufacturing method of the present embodiment.

### Glass Substrate for Chemical Strengthening Manufacturing Method

This glass substrate for chemical strengthening manufacturing method is a method for manufacturing a glass substrate for chemical strengthening including: (a) melting a frit material including, in mass percent,

| | |
|---|---|
| SiO₂ | 50%-70% |
| Al₂O₃ | 5%-20% |
| Na₂O | 6%-20% |
| K₂O | 0%-10% |
| MgO | 0%-10% |
| CaO | above 2%-20% |
| ZrO₂ | 0%-4.8% |

Wherein, (i) 46.5%≦(SiO₂−½Al₂O₃)≦59%, where SiO₂ and Al₂O₃ represent the mass percents of SiO₂ and Al₂O₃, respectively, in the frit material, (ii) 0.3<CaO/RO, where CaO represents the mass percent of CaO in the frit material and RO represents a total mass percent of one or more compounds selected from the group consisting of MgO, CaO, SrO and BaO included in the frit material, (iii) SrO+BaO<10%, where SrO and BaO represent mass percents of SrO and BaO, respectively, in the fit material, (iv) 0≦(ZrO₂+TiO₂)/SiO₂)<0.07, where ZrO₂ and TiO₂ represent the mass percents of ZrO₂ and TiO₂, respectively, in the frit material, and (v) 0≦B₂O₃/R¹₂O<0.1, where B₂O₃ represents a mass percent of B₂O₃ in the frit material and R¹₂O represents a total mass percent of one or more compounds selected from the group consisting of Li₂O, Na₂O and K₂O included in the frit material.

The method further includes (b) forming the glass substrate having a plate-shape by a down-draw glass forming method using the melted frit material.

The (a) step and the (b) step are respectively the same as the (x) step and the (y) step in the cover glass manufacturing method described above.

Next is a description of characteristics of the glass substrate for chemical strengthening, the chemically strengthened glass substrate, and the cover glass.

### Characteristics of Glass Substrate for Chemical Strengthening, Chemically Strengthened Glass Substrate, and Cover Glass

It is preferable that the glass constituting the glass substrate for chemical strengthening, the chemically strengthened glass substrate, and the cover glass of the present embodiment has the characteristics described below.

### Density

The density of the glass constituting the glass substrate for chemical strengthening, the chemically strengthened glass substrate, and the cover glass of the present embodiment is preferably less than or equal to 2.8 g/cm³, more preferably less than or equal to 2.7 g/cm³, even more preferably less than or equal to 2.6 g/cm³, and particularly preferably less than or equal to 2.55 g/cm³. The lower the density of the glass, the lighter the weight of the glass can be, and the more suitable the glass is for use in a cover glass, a touch panel display substrate, and the like.

### Linear Coefficient of Thermal Expansion

The linear coefficient of thermal expansion from 100° C. to 300° C. of the glass constituting the glass substrate for chemical strengthening, the chemically strengthened glass substrate, and the cover glass of the present embodiment is preferably 50×10⁻⁷/° C. to 120×10⁻⁷/° C., more preferably 60×10⁻⁷/° C. to 120×10⁻⁷/° C., even more preferably 70×10⁻⁷/° C. to 110×10⁻⁷/° C., and particularly preferably 80×10⁻⁷/° C. to 100×10⁻⁷/° C. Setting the linear coefficient of thermal expansion of the glass so as to be in these ranges makes it easier to match the coefficient of thermal expansion with that of peripheral materials such as metals and organic adhesives, and enables preventing detachment and the like of peripheral members.

### Liquidus Temperature (Tl)

The liquidus temperature of the glass constituting the glass substrate for chemical strengthening, the chemically strengthened glass substrate, and the cover glass of the present embodiment is preferably less than 1090° C., more preferably less than or equal to 1050° C., even more preferably less than or equal to 1000° C., and particularly preferably less than or equal to 960° C. The lower the liquidus temperature, the greater the ability to prevent the devitrification of the glass during plate formation. In other words, the lower the liquidus temperature, the greater the ability to improve the anti-devitrification characteristics, the more suitable the glass is for use in down-drawing, and the greater the ability to perform molding at lower temperatures, thus enabling a reduction in glass manufacturing cost as well. Also, the lower the liquidus temperature, the greater the ability to improve the moldability of the glass as well.

### Tg

The Tg of the glass constituting the glass substrate for chemical strengthening, the chemically strengthened glass substrate, and the cover glass of the present embodiment is preferably greater than 500° C., more preferably greater than or equal to 510° C., even more preferably greater than or equal to 530° C., even further preferably greater than or equal to 560° C., still further preferably greater than or equal to 580° C., and particularly preferably greater than or equal to 590° C. Setting Tg so as to be in these ranges enables preventing a reduction in heat resistance and the disappearance of the strengthened layer formed on the surface of the glass substrate through ion-exchange treatment. Note that it is also possible to suppress deformation of the glass substrate for chemical strengthening and the chemically strengthened glass substrate during heat treatment.

Also, [liquidus temperature—Tg] of the glass constituting the glass substrate for chemical strengthening, the chemically strengthened glass substrate, and the cover glass of the present embodiment is preferably less than or equal to 500° C., more preferably less than or equal to 450° C., even more preferably less than or equal to 400° C., even further preferably less than or equal to 380° C., and particularly preferably less than or equal to 370° C. Setting [liquidus temperature—Tg] so as to be in these ranges enables improving moldability.

### High-Temperature Viscosity

The high-temperature viscosity (temperature at which the viscosity is 200 Pa·s) of the glass constituting the glass substrate for chemical strengthening, the chemically strengthened glass substrate, and the cover glass of the present embodiment is preferably less than or equal to 1600° C., more preferably less than or equal to 1560° C., even more preferably less than or equal to 1540° C., and particularly preferably less than or equal to 1520° C. Setting the high-temperature viscosity so as to be in these ranges enables preventing a rise in the melting temperature and rise in the load on glass manufacturing equipment such as the melting furnace. It is also possible to improve the bubble quality of the glass. This enables inexpensively manufacturing glass.

### Strain Point

The strain point of the glass constituting the glass substrate for chemical strengthening, the chemically strengthened glass substrate, and the cover glass of the present embodiment is preferably greater than or equal to 500° C., more preferably greater than or equal to 520° C., even more preferably greater than or equal to 540° C., even further preferably greater than or equal to 550° C., and particularly preferably greater than or equal to 560° C. Setting the strain point so as to be in these ranges enables preventing a reduction in heat resistance and the disappearance of the strengthened layer formed on the surface of the glass substrate through ion-exchange treatment. Note that it is also possible to suppress deformation of the glass substrate and the chemically strengthened glass substrate during heat treatment.

### Plate Thickness

The plate thickness of the glass substrate for chemical strengthening, the chemically strengthened glass, and the cover glass of the present embodiment is preferably less than or equal to 3.0 mm, more preferably less than or equal to 2.0 mm, even more preferably less than or equal to 1.0 mm, and particularly preferably less than or equal to 0.8 mm. The lower the plate thickness of the glass substrate and the chemically strengthened glass, the lighter the weight, and the more suitable the glass is for use in a cover glass, a touch panel display substrate, or the like. Also, chemically strengthened glass that has been subjected to ion-exchange treatment does not readily break even if the plate thickness is low. For example, in the case of performing molding using down-drawing, even if polishing processing or the like is omitted, it is possible to obtain a glass substrate having a high mechanical strength, and that is thin and has favorable surface precision. However, if the plate thickness is too low, it is not possible to sufficiently raise the mechanical strength, and therefore the plate thickness of the chemically strengthened glass and the cover glass is preferably 0.3 mm to 1.5 mm, more preferably 0.3 mm to 1.0 mm, and even more preferably 0.4 mm to 0.7 mm.

### Compressive Stress Value

The compressive stress value of the glass constituting the chemically strengthened glass substrate and the cover glass of the present embodiment is preferably greater than or equal to 300 MPa, and more preferably greater than or equal to 400 MPa. Setting the compressive stress value in these ranges enables obtaining glass that has a strength sufficient for, for example, protecting a display or the like. Note that the higher the compressive stress value, the greater the improvement in the strength of the glass, but the greater the impact when the strengthened glass breaks. In order to prevent an accident due to such impact, the compressive stress value of the glass constituting the chemically strengthened glass substrate and the cover glass of the present embodiment is preferably less than or equal to 950 MPa, and more preferably less than or equal to 800 MPa. Specifically, the compressive stress value of the glass constituting the chemically strengthened glass substrate and the cover glass of the present embodiment is preferably 300 MPa to 950 MPa, more preferably 400 MPa to 900 MPa, even more preferably 550 MPa to 870 MPa, and even further preferably 600 MPa to 800 MPa.

### Compressive Layer Depth

The compressive layer depth of the glass constituting the chemically strengthened glass substrate and the cover glass of the present embodiment is 15 μm to 90 μm, preferably 20 μm to 80 μm, more preferably 25 μm to 70 μm, even more preferably 30 μm to 65 μm, and even further preferably 30 μm to 45 μm.

Note that there has been a tendency to reduce the plate thickness of cover glass in recent years in order to reduce the weight, and although this is accompanied by a reduction in the compressive layer depth, there is demand for having a compressive stress value that is a predetermined value or greater. Specifically, it is preferable that the plate thickness of the cover glass is 0.3 mm to 1.5 mm, the compressive layer depth is 25 μm to 70 μm, and the compressive stress value is 400 MPa to 900 MPa, it is more preferable that the plate thickness of the cover glass is 0.3 mm to 1.0 mm, the compressive layer depth is 30 μm to 65 μm, and the compressive stress value is 550 MPa to 870 MPa, and it is even more preferable that the plate thickness of the cover glass is 0.3 mm to 1.0 mm, the compressive layer depth is 30 μm to 45 μm, and the compressive stress value is 600 MPa to 800 MPa.

### Liquid-Phase Viscosity

The liquid-phase viscosity of the glass constituting the glass substrate for chemical strengthening and the cover glass of the present embodiment is greater than or equal to 160 kpoise, preferably greater than or equal to 300 kpoise, more preferably greater than or equal to 400 kpoise, and even more preferably greater than or equal to 500 kpoise. If the liquid-phase viscosity is greater than or equal to 160 kpoise, the glass is suitable for down-drawing, and it is also possible to reduce manufacturing cost.

Note that in order to achieve stable manufacturing using down-drawing (in particularly, overflow down-drawing), it is necessary that the liquid-phase viscosity is greater than or equal to 160 kpoise, and the devitrification temperature (liquidus temperature) is less than or equal to 1200° C. In order to suppress devitrification and more stably manufacture a chemically strengthened glass substrate and cover glass, it is preferable that the liquid-phase viscosity is greater than or equal to 300 kpoise, and the devitrification temperature (liquidus temperature) is less than 1090° C., and it is more preferable that the liquid-phase viscosity is greater than or equal to 400 kpoise, and the devitrification temperature (liquidus temperature) is less than or equal to 1050° C.

### Etching Speed

The etching speed, as measured by a method described later, of the glass constituting the glass substrate for chemical strengthening of the present embodiment is preferably greater than or equal to 2.4 μm/min, more preferably greater than or equal to 3 μm/min, even more preferably greater than or equal to 3.5 μm/min, and particularly preferably greater than or equal to 4 μm/min. Setting the etching speed so as to be in these ranges enables improving the speed of shape modification performed on the glass and end face processing performed using etching, and enables improving yield. Note that the higher the etching speed, the greater the improvement in the glass product production capacity, but the liquidus temperature rises as the etching speed rises. In view of this, in order to obtain both favorable anti-devitrification characteristics and an improvement in etching speed, the etching speed of the glass constituting the glass substrate of the present embodiment is preferably less than or equal to 10 μm/min, more preferably less than or equal to 8 μm/min, even more preferably less than or equal to 7 μm/min, and particularly preferably less than or equal to 6.5 μm/min. Specifically, the etching speed of the glass constituting the glass substrate of the present embodiment is preferably 2.4 to 10 μm/min, more preferably 3.0 to 8 μm/min, even more preferably 3.5 to 7 μm/min, and particularly preferably 4 to 6.5 μm/min.

### WORKING EXAMPLES

Next, a more detailed description of the present invention is given using working examples. Note that the present invention is not limited in any way to these examples.

It should be noted that the notation “N/A” in the tables indicates that the corresponding characteristics have not yet been measured.

### Working Examples 1 to 18 and Comparative Examples 1 to 12

### Glass Preparation

First, frit materials (batches) were prepared using silica, alumina, sodium carbonate, potassium carbonate, basic magnesium carbonate, calcium carbonate, strontium carbonate, barium carbonate, titanium oxide, and zirconium oxide, which are normal frit materials, so as to have the glass compositions show in Table 1-1, Table 1-2, Table 2-1, and Table 2-2. Melt glass was obtained by heating the prepared batches in an electric furnace held at 1550° C. for four hours using a platinum crucible, and glass blocks were obtained by performing cooling by passing the melt glass over an iron plate outside the furnace. The glass was then held at 600° C. for 30 minutes in the electric furnace, thereafter the power of the furnace was turned off, and the glass was slowly cooled to room temperature, thus obtaining glass samples for glass property evaluation.

The following characteristics were evaluated for the glass samples obtained as described above.

### Liquidus Temperature

The glass samples were crushed, and the glass pieces that passed through a 2380 μm sieve and remained on a 1000 μm sieve were immersed in ethanol, subjected to ultrasonic cleaning, and then dried in a temperature-controlled oven. Next, 25 g of the glass pieces was placed on a 12-mm wide, 200-mm long, and 10-mm thick platinum board so as to have a substantially constant thickness, and then held for 24 hours in an electric furnace having a temperature gradient of 800° C. to 1200° C. Thereafter, the glass was removed from the furnace, devitrification that occurred inside the glass was observed using a 40× optical microscope, and the highest temperature at which devitrification was observed was used as the liquidus temperature.

### Strain Point

The glass samples were cut and ground into a prismatic shape having 3 mm sides and a length of 55 mm, and the strain point Ps was measured using a beam bending measurement apparatus (made by Tokyo Kogyo Co., Ltd.). The strain points were obtained by calculation in accordance with a beam bending method (ASTM C-598).

### Coefficient of Thermal Expansion and Tg

The glass samples were modified so as to have cylindrical shape with a φ of 5 mm and a length of 20 mm, and the coefficient of thermal expansion and the glass transition temperature Tg were measured using a differential thermal expansion meter (Thermo Plus2 TMA8310). The average coefficient of thermal expansion in the temperature range of 100° C. to 300° C. was calculated based on the results of measuring the coefficient of thermal expansion.

### Density

The density was measured using the Archimedean method.

### High-Temperature Viscosity

The glass samples were melted for four hours at 1600° C. and defoamed, and the high-temperature region viscosity was measured using a falling sphere automatic viscometer. More specifically, the viscosities of the samples were obtained by suspending a platinum sphere in the melted glass samples and measuring, as the load, the viscosity resistance exerted on the sphere while falling down through the sample in each container. Table 1-2 and Table 2-2 show the temperatures at which the viscosities of the glass were 200 dPa·s.

### Striae

The glass samples obtained as described above were visually observed, and striae (composition unevenness) was observed using the following determination references.

Excellent: No lines whatsoever appeared

Good: Very few lines were observed

Poor: Lines were observed

### Etching Speed

Sample sheets were formed with the dimensions 50×40×0.7 mm by performing cutting, grinding, and polishing on the glass samples. The sample sheets were then cleaned, and thereafter analytical samples were immersed for 20 minutes in a container containing 400 ml of HF (concentration of 10 mass %, temperature of 22° C.). The samples were then cleaned with water, the thickness and mass from before and after experimentation were measured, and the etching speeds of the glass samples were calculated.

### Chemical Strengthening Processing

Next, after being cleaned, the glass samples were immersed for approximately five hours in a treating bath made up of 100% KNO₃ and kept at approximately 500° C., and Na⁺ ions in the surface portion of the glass were exchanged with K⁺ ions in the treating bath, thus performing chemical strengthening. After being subjected to chemical strengthening, the glass substrates were cleaned by successive immersion in a washing tank, and then dried, thus obtaining strengthened glass.

### Compressive Stress Value

A surface stress meter (FSM-6000LE, manufactured by Luceo Co., Ltd.) was used to observe the number of interference fringes and intervals therebetween in the strengthened glass obtained as described above, and the thickness of the compressive stress layer and the compressive stress value of the compressive stress layer in the vicinity of the glass surface were calculated. When performing calculation, the refractive index (nd) of each sample was 1.52, and the stress optical coefficient was 28 [(nm/cm)/MPa].

These characteristic evaluation results are shown in Table 1-3 and Table 2-3.

TABLE 1-1

| | | Glass Composition (mass %) | | | | | | | | |
|---|---|---|---|---|---|---|---|---|---|---|
| | | SiO₂ | Al₂O₃ | Na₂O | K₂O | MgO | CaO | ZrO₂ | SnO₂ | SO₃ |
| Working Example | 1 | 62.6 | 17.4 | 15.4 | | 1.9 | 2.6 | | | 0.1 |
| | 2 | 60.8 | 13.7 | 15.8 | | 2.2 | 3.2 | 4.2 | 0.1 | |
| | 3 | 62.8 | 14.7 | 15.8 | | 2.2 | 3.2 | 1.2 | | 0.1 |
| | 4 | 60.2 | 14.7 | 13.1 | 3.3 | 2.2 | 3.2 | 3.2 | 0.1 | |
| | 5 | 60.2 | 13.1 | 14.5 | 3.3 | 2.2 | 3.2 | 3.4 | | 0.1 |
| | 6 | 62.4 | 13.1 | 14.5 | 3.3 | 2.2 | 3.2 | 1.2 | 0.1 | |
| | 7 | 60.8 | 14.7 | 14.5 | 3.3 | 2.2 | 3.2 | 1.2 | 0.1 | |
| | 8 | 63.2 | 12.3 | 14.5 | 3.3 | 2.2 | 3.2 | 1.2 | | 0.1 |
| | 9 | 61.3 | 12.8 | 12.9 | 3.3 | 2.2 | 3.2 | 4.2 | 0.1 | |
| | 10 | 56 | 17.3 | 14.5 | 3.3 | 2.2 | 3.2 | 3.4 | 0.1 | |
| | 11 | 58.0 | 15.3 | 14.5 | 3.3 | 2.2 | 3.2 | 3.4 | 0.1 | |
| | 12 | 62.0 | 11.3 | 14.5 | 3.3 | 2.2 | 3.2 | 3.4 | 0.1 | |
| | 13 | 63.0 | 10.3 | 14.5 | 3.3 | 2.2 | 3.2 | 3.4 | | 0.1 |
| | 14 | 63.7 | 9.7 | 14.5 | 3.3 | 2.2 | 3.2 | 3.4 | | 0.1 |
| | 15 | 60.2 | 13.1 | 14.5 | 3.3 | | 5.4 | 3.4 | 0.1 | |
| | 16 | 60.2 | 13.1 | 14.5 | 3.3 | 3.3 | 2.1 | 3.4 | 0.1 | |
| | 17 | 61.4 | 17.0 | 11.3 | 5.7 | 1.8 | 2.6 | 0.0 | 0.1 | |
| | 18 | 60.8 | 11.7 | 15.8 | 2.0 | 2.2 | 3.2 | 4.2 | | 0.1 |

TABLE 1-2

| | | Characteristic Values of Glass Composition | | | | | | | |
|---|---|---|---|---|---|---|---|---|---|
| | | | | | | B₂O₃/ | (ZrO₂ + TiO₂)/ | Li₂O/ | (ZrO₂ + TiO₂ + ½B₂O₃ + |
| | | RO | CaO/RO | SiO₂ − ½Al₂O₃ | SrO + BaO | R¹₂O | SiO₂ | (RO + Li₂O) | ½Na₂O)/SiO₂ |
| Working | 1 | 4.5 | 0.58 | 53.9 | 0 | 0 | 0 | 0 | 0.12 |
| Example | 2 | 5.4 | 0.59 | 54.0 | 0 | 0 | 0.069 | 0 | 0.20 |
| | 3 | 5.4 | 0.59 | 55.5 | 0 | 0 | 0.019 | 0 | 0.14 |
| | 4 | 5.4 | 0.59 | 52.9 | 0 | 0 | 0.053 | 0 | 0.16 |
| | 5 | 5.4 | 0.59 | 53.7 | 0 | 0 | 0.056 | 0 | 0.18 |
| | 6 | 5.4 | 0.59 | 55.9 | 0 | 0 | 0.019 | 0 | 0.14 |
| | 7 | 5.4 | 0.59 | 53.5 | 0 | 0 | 0.020 | 0 | 0.14 |
| | 8 | 5.4 | 0.59 | 57.1 | 0 | 0 | 0.019 | 0 | 0.13 |
| | 9 | 5.4 | 0.59 | 53.7 | 0 | 0 | 0.080 | 0 | 0.19 |
| | 10 | 5.4 | 0.59 | 47.4 | 0 | 0 | 0.061 | 0 | 0.19 |
| | 11 | 5.4 | 0.59 | 50.4 | 0 | 0 | 0.059 | 0 | 0.18 |
| | 12 | 5.4 | 0.59 | 56.4 | 0 | 0 | 0.055 | 0 | 0.17 |
| | 13 | 5.4 | 0.59 | 57.9 | 0 | 0 | 0.054 | 0 | 0.17 |
| | 14 | 5.4 | 0.59 | 58.9 | 0 | 0 | 0.053 | 0 | 0.17 |
| | 15 | 5.4 | 1.00 | 53.7 | 0 | 0 | 0.056 | 0 | 0.18 |
| | 16 | 5.4 | 0.39 | 53.7 | 0 | 0 | 0.056 | 0 | 0.18 |
| | 17 | 4.4 | 0.59 | 52.9 | 0 | 0 | 0.000 | 0 | 0.09 |
| | 18 | 5.4 | 0.59 | 55.0 | 0 | 0 | 0.069 | 0 | 0.20 |

TABLE 1-3

| | | Glass Characteristics | | | | | | | | | | | |
|---|---|---|---|---|---|---|---|---|---|---|---|---|---|
| | | | | | | | Tg | Avg. | | Com- | | Com- | |
| | | Tl | | | | | (Glass | coefficient | | pressive | | pressive | Liquid- |
| | | (Liquidus | | High-temp | Strain | Etching | transition | of thermal | | stress | | layer | phase |
| | | temp.) | Appearance | viscosity | point | speed | temp.) | expansion | Tl − Tg | value | Density | depth | viscosity |
| | | (° C.) | Striae | (° C.) | (° C.) | (μm/min) | (° C.) | [×10⁻⁷/° C.] | (° C.) | (MPa) | (g/cm³) | (μm) | (kpoise) |
| Working | 1 | 1000 | Excellent | | 563 | 6.1 | 610 | 89 | 390 | | 2.46 | | |
| Example | 2 | 978 | Excellent | 1517 | 581 | 5.4 | 618 | 83 | 360 | | | | |
| | 3 | 1021 | Good | | 558 | 4.9 | 604 | 89 | 417 | | 2.49 | | |
| | 4 | 1045 | Good | | | 4.0 | 615 | 91 | 430 | | 2.51 | | |
| | 5 | 948 | Excellent | 1508 | 563 | 5.1 | 593 | 95 | 355 | 659 | 2.52 | 40 | 814 |
| | 6 | 927 | Excellent | | | 4.3 | 578 | 97 | 349 | | 2.49 | | |
| | 7 | 988 | Excellent | | | 5.2 | 592 | 97 | 396 | | 2.49 | | |
| | 8 | 928 | Excellent | 1514 | 521 | 3.6 | 574 | 99 | 354 | 527 | 2.48 | | |
| | 9 | 1003 | Excellent | 1542 | 582 | 5 | 616 | 90 | 387 | 768 | 2.54 | 35 | |
| | 10 | 1018 | Excellent | | | 5.2 | 626 | 91 | 392 | | | | |
| | 11 | 1003 | Excellent | | 570 | 6.5 | 614 | 91 | 389 | 864 | 2.53 | 41 | |
| | 12 | 968 | Excellent | | 537 | 4.1 | 586 | 91 | 382 | 707 | 2.51 | 36 | |
| | 13 | 855 | Excellent | | 530 | 3.5 | 576 | 90 | 279 | | | | |
| | 14 | 836 | Excellent | | | 2.9 | 571 | 90 | 265 | | | | |
| | 15 | 1011 | Excellent | | | | 592 | 92 | 419 | | 2.54 | | |
| | 16 | 1031 | Excellent | | | | 600 | 91 | 431 | | 2.52 | | |
| | 17 | 1060 | Good | | 560 | | 611 | 94 | 449 | | 2.45 | | |
| | 18 | 921 | Excellent | | | | 595 | 94 | 326 | | 2.55 | | |

TABLE 2-1

| | | Glass Composition (mass %) | | | | | | | | | | | | | |
|---|---|---|---|---|---|---|---|---|---|---|---|---|---|---|---|
| | | SiO₂ | Al₂O₃ | Li₂O | Na₂O | K₂O | MgO | CaO | ZrO₂ | SnO₂ | B₂O₃ | TiO₂ | BaO | SrO | SO₃ |
| Comparative Example | 1 | 59.1 | 13.0 | | 14.0 | 2.8 | 2.4 | 2.0 | 6.6 | 0.1 | | | | | |
| | 2 | 56.9 | 9.7 | | 13.6 | 5.6 | 1.2 | 2.0 | 10.9 | 0.1 | | | | | |
| | 3 | 61.9 | 17.2 | | 11.4 | | 6.8 | 2.6 | | 0.1 | | | | | |
| | 4 | 60.2 | 13.1 | | 14.5 | 3.3 | 3.9 | 1.5 | 3.4 | 0.1 | | | | | |
| | 5 | 60.2 | 13.1 | | 14.5 | 3.3 | 5.4 | 0.0 | 3.4 | 0.1 | | | | | |
| | 6 | 54.0 | 19.3 | | 14.5 | 3.3 | 2.2 | 3.2 | 3.4 | 0.1 | | | | | |
| | 7 | 55.0 | 4.5 | | 9.5 | 3.0 | 10.5 | 14.4 | 3.0 | 0.1 | | | | | |
| | 8 | 65.5 | 6.0 | | 5.5 | 0.5 | 9.0 | 12.7 | 0.7 | 0.1 | | | | | |
| | 9 | 52.9 | 16.0 | | 16.0 | 2.0 | 2.0 | 2.0 | 2.5 | 0.1 | 2.0 | 4.5 | | | |
| | 10 | 55.6 | 7.0 | | 4.6 | 6.9 | 1.9 | 2.1 | 4.5 | 0.1 | | | 8.9 | 8.4 | |
| | 11 | 65 | 8.3 | | 14.5 | 3.3 | 2.2 | 3.2 | 3.4 | | | | | | 0.1 |
| | 12 | 67 | 6.3 | | 14.5 | 3.3 | 2.2 | 3.2 | 3.4 | | | | | | 0.1 |

TABLE 2-2

| | | Characteristic Values of Glass Composition | | | | | | | |
|---|---|---|---|---|---|---|---|---|---|
| | | | CaO/ | | | B₂O₃/ | (ZrO₂ + TiO₂)/ | Li₂O/ | (ZrO₂ + TiO₂ + ½B₂O₃ + |
| | | RO | RO | SiO₂ − ½Al₂O₃ | SrO + BaO | R¹₂O | SiO₂ | (RO + Li₂O) | ½Na₂O)/SiO₂ |
| Comparative | 1 | 4.4 | 0.45 | 52.6 | 0 | 0 | 0.112 | 0 | 0.23 |
| Example | 2 | 3.2 | 0.63 | 52.1 | 0 | 0 | 0.192 | 0 | 0.31 |
| | 3 | 9.4 | 0.28 | 53.3 | 0 | 0 | 0.000 | 0 | 0.09 |
| | 4 | 5.4 | 0.28 | 53.7 | 0 | 0 | 0.056 | 0 | 0.18 |
| | 5 | 5.4 | 0.00 | 53.7 | 0 | 0 | 0.056 | 0 | 0.18 |
| | 6 | 5.4 | 0.59 | 44.4 | 0 | 0 | 0.063 | 0 | 0.20 |
| | 7 | 24.9 | 0.58 | 52.8 | 0 | 0 | 0.055 | 0 | 0.14 |
| | 8 | 21.7 | 0.59 | 62.5 | 0 | 0 | 0.011 | 0 | 0.05 |
| | 9 | 4 | 0.50 | 44.9 | 0 | 0.11 | 2.585 | 0 | 0.30 |
| | 10 | 21.3 | 0.53 | 52.1 | 17.3 | 0 | 0.081 | 0 | 0.12 |
| | 11 | 5.4 | 0.59 | 60.9 | 0 | 0 | 0.052 | 0 | 0.16 |
| | 12 | 5.4 | 0.59 | 63.9 | 0 | 0 | 0.051 | 0 | 0.16 |

TABLE 2-3

| | | Glass Characteristics | | | | | | | | |
|---|---|---|---|---|---|---|---|---|---|---|
| | | | | | | | Avg. coefficient | | | |
| | | Tl | | Strain | Etching | Tg | of thermal | | Compressive | |
| | | (Liquidus temp.) | Appearance | point | speed | (Glass transition temp.) | expansion | Tl − Tg | stress value | Density |
| | | (° C.) | Striae | (° C.) | (μm/min) | (° C.) | [×10⁻⁷/° C.] | (° C.) | (MPa) | (g/cm³) |
| Comparative | 1 | 1163 | Poor | 582 | | 630 | 90 | 533 | | 2.56 |
| Example | 2 | 1160 | Poor | 572 | | 623 | | 537 | | 2.62 |
| | 3 | 1200 | Poor | | | 662 | 71 | 538 | | 2.48 |
| | 4 | 1112 | Poor | | 4.6 | 620 | 91 | 492 | | 2.50 |
| | 5 | 1164 | Poor | | 4 | 619 | 87 | 545 | | 2.57 |
| | 6 | 1200 | Poor | 587 | 5.3 | 636 | 92 | 564 | | |
| | 7 | 1200 | Poor | 573 | | 620 | 87 | 580 | | |
| | 8 | 1200 | Poor | | | 660 | 68 | 540 | | |
| | 9 | N/A | N/A | | | | | | 1340 | |
| | 10 | N/A | N/A | | | | | | | 2.85 |
| | 11 | 858 | N/A | | 2.3 | 563 | 90 | 295 | | |
| | 12 | 830 | N/A | | 1.8 | 554 | 90 | 276 | | |

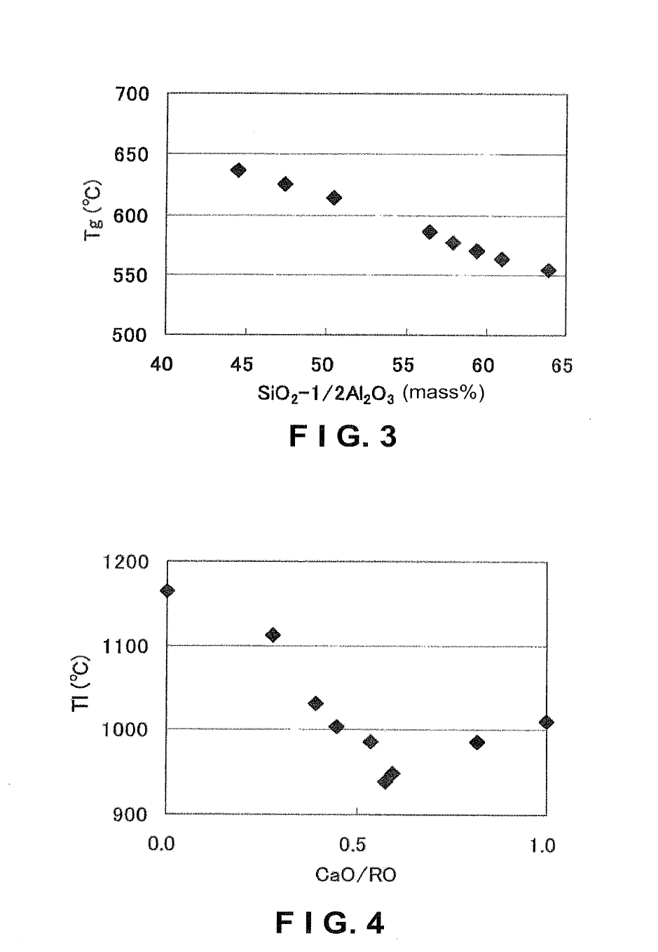

FIG. 1 is a graph showing the relationship between [SiO₂ content percent−½ Al₂O₃ content percent] and etching speed, FIG. 2 is a graph showing the relationship between [SiO₂ content percent−½ Al₂O₃ content percent] and liquidus temperature (Tl), FIG. 3 is a graph showing the relationship between [SiO₂ content percent−½ Al₂O₃ content percent] and glass transition temperature (Tg), and FIG. 4 is a graph showing the relationship between CaO/RO content ratio and liquidus temperature (Tl).

As is clearly shown in Table 1-3, with working examples 1 to 18, the liquidus temperature was less than 1090° C., and the etching speed was greater than or equal to 2.4 μm/min, and therefore both favorable anti-devitrification characteristics and an improvement in the etching speed were obtained. For this reason, it is possible to also sufficiently improve the yield of cover glass and the like.

In addition to the above-described effect, the strain point of the working examples 1 to 18 was high at greater than or equal to 505° C., and therefore it is thought that the compressive stress value of the compressive stress layer does not readily decrease even when heat treatment is performed. Furthermore, the working examples 1 to 18 had a Tg of greater than or equal to 550° C., and thus had excellent heat resistance. Note that since the compressive stress value of the compressive stress layer was in the range of 350 MPa to 950 MPa, the amount of impact during breaking can be reduced.

Also, since the average coefficient of thermal expansion of the working examples 1 to 18 was 80×10⁻⁷/° C. to 110×10⁻⁷/° C., it is easier to match the coefficient of thermal expansion with that of peripheral materials such as metals and organic adhesives, and it is possible to prevent detachment and the like of peripheral members. Furthermore, since the density of the working examples 1 to 18 was less than or equal to 2.8 g/cm³, it is possible to sufficiently reduce the weight so as to be able to be applied to use as a cover glass or the like.

### Example of Continuous Manufacturing of Glass Substrates for Strengthening

Frit material prepared so as to have the composition shown in working example 12 was dissolved at 1520° C., clarified at 1550° C., and agitated at 1350° C. using a continuous dissolution apparatus including a dissolution tank made of fireproof brick, an agitation tank made of platinum, and the like. Thereafter the glass was formed into a thin plate shape having a thickness of 0.7 mm using down-drawing, thus obtaining a glass substrate for chemical strengthening. Also, etching and chemical strengthening were performed using methods such as the following.

First, a cover glass shaped phenol-based thermosetting resin pattern was formed to a thickness of 20 μm on both main surfaces of a glass substrate sample using a mesh screen printing method, and the phenol-based thermosetting resin pattern was subjected to baking processing at 200° C. for 15 minutes. The glass sample was then cut to a predetermined shape by etching an etching target area on both main surface sides using the phenol-based thermosetting resin pattern as the mask and using a mixed acid aqueous solution (40° C.) including hydrofluoric acid (15 mass %) and sulfuric acid (24 mass %) as the etchant. Thereafter, the phenol-based thermosetting resin remaining on the glass was removed from the glass by being dissolved using an NaOH solution, and rinse processing was performed.

Next, after being cleaned, the glass sample was immersed for approximately five hours in a treating bath made up of 100% KNO₃ and kept at approximately 500° C., and Na⁺ ions in the surface portion of the glass were exchanged with K⁺ ions in the treating bath, thus performing chemical strengthening. After being subjected to chemical strengthening, the glass substrate was cleaned by successive immersion in a washing tank, and then dried.

As a result, it is possible to obtain a glass substrate for chemical strengthening and a chemically strengthened glass substrate having favorable quality and a sufficiently improved etching speed.

A chemically strengthened glass substrate of the present invention can be favorably used as the cover glass of a mobile phone, a digital camera, a PDA (mobile terminal), a solar cell, or a flat panel display, and additionally, shows promise in applications in which high mechanical strength is required, such as application as a touch panel display substrate, window glass, a magnetic disk substrate, a flat panel display substrate, a solid-state imaging sensor cover glass, dinnerware, and the like.

1. A glass substrate having a down-drawable composition comprising, in mass percent:

| | |
|---|---|
| SiO₂ | 50%-70% |
| Al₂O₃ | 5%-20% |
| Na₂O | 6%-20% |
| K₂O | 0%-10% |
| MgO | 0%-10% |
| CaO | above 2%-20% |
| ZrO₂ | 0%-4.8% |

wherein,
(i) 46.5%≦(SiO₂−½Al₂O₃)≦59%, where SiO₂ and Al₂O₃ represent the mass percents of SiO₂ and Al₂O₃, respectively, in the glass substrate,
(ii) 0.3<CaO/RO, where CaO represents the mass percent of CaO in the glass substrate and RO represents a total mass percent of one or more compounds selected from the group consisting of MgO, CaO, SrO and BaO included in the glass substrate,
(iii) SrO+BaO<10%, where SrO and BaO represent mass percents of SrO and BaO, respectively, in the glass substrate,
(iv) 0≦(ZrO₂+TiO₂)/SiO₂)<0.07, where ZrO₂ and TiO₂ represent the mass percents of ZrO₂ and TiO₂, respectively, in the glass substrate, and
(v) 0≦B₂O₃/R¹₂O<0.1, where B₂O₃ represents a mass percent of B₂O₃ in the glass substrate and R¹₂O represents a total mass percent of one or more compounds selected from the group consisting of Li₂O, Na₂O and K₂O included in the glass substrate.

2. The glass substrate as recited in claim 1, wherein
Li₂O/(RO+Li₂O)<0.3, where Li₂O represents the mass percent of Li₂O in the glass substrate.

3. The glass substrate as recited in claim 1, wherein
4%<RO.

4. The glass substrate as recited in claim 1, wherein
(ZrO₂+TiO₂+½B₂O₃+½Na₂O)/SiO₂<0.3, where Na₂O represent the mass percent of Na₂O in the glass substrate.

5. The glass substrate as recited in claim 1, wherein
TiO₂<3%.

6. The glass substrate as recited in claim 1, wherein
a liquidus temperature of the glass substrate is less than 1090° C.

7. A chemically strengthened glass substrate comprising:
the glass substrate according to claim 1 including a compressive stress layer at a surface of thereof, which is formed by a chemically strengthening treatment applied to the glass substrate.

8. The chemically strengthened glass substrate as recited in claim 7, wherein
a plate thickness of the glass substrate is 0.3 mm to 1.5 mm, a compressive layer depth is 25 μm to 70 μm and a compressive stress value is 400 MPa to 900 MPa.

9. A cover glass comprising:
the chemically strengthened glass substrate according to claim 7.

10. The cover glass as recited in claim 9, wherein
a plate thickness of the glass substrate is 0.3 mm to 1.5 mm, a compressive layer depth is 25 μm to 70 μm and a compressive stress value is 400 MPa to 900 MPa.

11. A method for manufacturing a glass substrate comprising:
melting a glass raw material blended so as to have a glass composition comprising, in mass percent,

| | |
|---|---|
| SiO₂ | 50%-70% |
| Al₂O₃ | 5%-20% |
| Na₂O | 6%-20% |
| K₂O | 0%-10% |
| MgO | 0%-10% |
| CaO | above 2%-20% |
| ZrO₂ | 0%-4.8% |

wherein,
(i) 46.5%≦(SiO₂−½Al₂O₃)≦59%, where SiO₂ and Al₂O₃ represent the mass percents of SiO₂ and Al₂O₃, respectively, in the frit material,
(ii) 0.3<CaO/RO, where CaO represents the mass percent of CaO in the frit material and RO represents a total mass percent of one or more compounds selected from the group consisting of MgO, CaO, SrO and BaO included in the frit material,
(iii) SrO+BaO<10%, where SrO and BaO represent mass percents of SrO and BaO, respectively, in the frit material,
(iv) 0≦(ZrO₂+TiO₂)/SiO₂)<0.07, where ZrO₂ and TiO₂ represent the mass percents of ZrO₂ and TiO₂, respectively, in the frit material, and
(v) 0≦B₂O₃/R¹₂O<0.1, where B₂O₃ represents a mass percent of B₂O₃ in the frit material and R¹₂O represents a total mass percent of one or more compounds selected from the group consisting of Li₂O, Na₂O and K₂O included in the frit material; and
forming the glass substrate having a plate-shape by a down-draw glass forming method using the melted frit material.

12. The method as recited in claim 11, wherein
in the frit material, Li₂O/(RO+Li₂O)<0.3, where Li₂O represents the mass percent of Li₂O in the frit material.

13. The method as recited in claim 11, wherein
in the frit material, 4%<RO.

14. The method as recited in claim 11, wherein
in the frit material, (ZrO₂+TiO₂+½B₂O₃+½Na₂O)/SiO₂<0.3, where Na₂O represent the mass percent of Na₂O in the frit material.

15. The method as recited in claim 11, wherein
in the frit material, TiO₂<3%.

16. A method for manufacturing a chemically strengthened glass substrate comprising:
preparing the glass substrate by using the method according to claim 11; and
applying an ion-exchange treatment to the glass substrate.

17. A method for manufacturing a cover glass comprising:
preparing the glass substrate by using the method according to claim 11; and
performing etching on the glass substrate.

18. The method as recited in claim 17, further comprising
applying an ion-exchange treatment to the glass substrate after the performing of the etching.

19. A glass substrate manufactured by the method according to claim 11.

20. A chemically strengthened glass substrate manufactured by the method according to claim 16.

21. A cover glass manufactured by the method according to claim 17.
